(19) United States
(12) Patent Application Publication
(10) Pub. No.: US 2025/0166001 A1
(43) Pub. Date: May 22, 2025

(54) DETERMINING CONDITIONS AND INCENTIVES ASSOCIATED WITH INSTALLMENT OPTIONS

(71) Applicant: Synchrony Bank, Stamford, CT (US)

(72) Inventors: John Taylor, Stamford, CT (US); Shruti Joshi, Stamford, CT (US); Melissa Schalmo, Stamford, CT (US); Kim Mock, Stamford, CT (US); Joseph Gauthier, Stamford, CT (US)

(21) Appl. No.: 18/955,436

(22) Filed: Nov. 21, 2024

Related U.S. Application Data
(60) Provisional application No. 63/601,290, filed on Nov. 21, 2023.

(51) Int. Cl. G06Q 30/0207

(52) U.S. Cl. CPC G06Q 30/0215

(57) ABSTRACT

Disclosed embodiments may provide techniques for configuring conditions and incentives associated with installment options. A computer-implemented method can include identifying an installment option and an alternative installment option associated with an account. In some instances, the alternative installment option is associated with an incentive, which can be applied when one or more conditions associated with the account are satisfied. The computer-implemented method can also include receiving a user selection of the alternative installment option. The computer-implemented method can also include detecting in real-time a set of actions performed for the account, in which the set of actions can be associated with the one or more conditions. The computer-implemented method can also include determining in real-time that the one or more conditions have been satisfied based on the set of actions. The computer-implemented method can also include processing the incentive associated with the alternative installment option.

### CROSS-REFERENCE TO RELATED APPLICATIONS

This application claims the priority benefit of U.S. Provisional Patent Application No. 63/601,290, filed Nov. 21, 2023, the disclosures of which are incorporated by reference herein its entirety and for all purposes.

### FIELD

The present disclosure relates generally to determining conditions and incentives associated with installment options. In one example, the systems and methods described herein may be used to determine conditions and incentives that facilitate completion of installment options associated with a user.

### SUMMARY

Disclosed embodiments may provide techniques for configuring conditions and incentives associated with installment options. A computer-implemented method can include identifying an installment option associated with an account. In some instances, the installment option identifies a first recurring transfer of resources across a time period. The computer-implemented method can also include determining one or more conditions for transferring the resources. In some instances, the one or more conditions include payment of an entirety of resources associated with the account before a particular date, in which the particular date is earlier than a maturation date associated with the time period. The one or more conditions can also include activating an automatic withdrawal of the resources that are associated with a corresponding recurring transfer. In some instances, the one or more conditions include one or more condition parameters, in which the one or more condition parameters are determined by applying a machine-learning model to profile data of a user associated with the account.

The computer-implemented method can also include determining an alternative installment option associated with the account. In some instances, the alternative installment option identifies a second recurring transfer of resources across the time period. In addition, the alternative installment option can be associated with an incentive associated with the account, in which the incentive is applied when the one or more conditions are satisfied. For example, if the installment option indicates an interest rate associated with resources of the account, the incentive of the alternative installment option can include a reduction of the interest rate associated with the installment option. In another example, if the installment option indicates an amount of interest to be applied to the resources of the account, the incentive of the alternative installment option can include waiving an entirety the indicated amount of interest.

In some instances, the incentive is associated with a particular type, in which the particular type of the incentive is determined by applying another machine-learning model to profile data of a user associated with the account. In addition, the incentive can also include one or more incentive parameters, in which the one or more incentive parameters are determined by applying the other machine-learning model to profile data of a user associated with the account.

The computer-implemented method can also include transmitting the installment option and the alternative installment option. When the installment option and the alternative installment option are received, a web service can cause the installment option and the alternative installment option to be displayed on one or more web pages. The computer-implemented method can also include receiving a user selection of the alternative installment option.

The computer-implemented method can also include detecting in real-time a set of actions performed for the account, in which the set of actions can be associated with the one or more conditions. In some instances, the set of actions are detected in real-time as a plurality of actions continue to be performed for the account.

The computer-implemented method can also include determining in real-time that the one or more conditions have been satisfied based on the set of actions. In some instances, the one or more conditions are determined to have been satisfied in real-time as the plurality of actions continue to be performed for the account. The computer-implemented method can also include processing the incentive associated with the alternative installment option.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram for determining conditions and incentives associated with installment options, according to some embodiments.

FIG. 2 illustrates an example computing environment for determining conditions and incentives associated with installment options, according to some embodiments.

FIG. 3 illustrates an example computing environment that includes a special-purpose computer configured to determine conditions and incentives associated with installment options, according to some embodiments.

FIG. 4 shows an illustrative example of a process for determining conditions and incentives associated with installment options, in accordance with some embodiments.

FIG. 5 illustrates an example architecture of a neural network for determining conditions and incentives associated with installment options, according to some embodiments

FIG. 6 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide techniques for configuring conditions and incentives associated with installment options. An incentive-management application can identify an installment option associated with an account. The installment option can identify a first recurring transfer of resources across a time period. In some instances, the resources were provided by a resource provider to complete a particular transaction for a user. As an illustrative example, a user accessing an ecommerce website can obtain resources to purchase a laptop device, in which the resources are provided by a financial institution. By providing the resources, the resource provider can activate an account associated with the borrowed resources. To return the resources of the account, the user can be enrolled in an installment option that indicates a recurring transfer of a portion of the resources over a time period (e.g., 48 months). In some instances, the installment option is associated an interest to be added to the resources. The interest can be determined based on a percentage of the borrowed resources (e.g., an interest rate). Continuing with the example, the interest can be determined based on 24.99% annual percentage rate of the resources obtained to purchase the laptop device.

To facilitate return of the resources, the resource provider can provide various incentives when certain conditions are satisfied. In particular, the incentive-management application can determine one or more conditions associated with transferring the resources. The conditions can specify certain actions to be performed for the account. When the actions are completed, the resource provider can provide the incentives for the account. Continuing with the example, the conditions can include transferring the entirety of resources associated with the account before 24 months, instead of the default maturation date of 48 months. In another example, the conditions can include activating an automatic withdrawal of the resources (e.g., autopay) associated with the account.

The conditions can be associated with corresponding parameters. The condition parameters can be adjusted to entice the user to perform actions associated with the conditions and thereby facilitate the satisfaction of the conditions. Continuing with the example, the condition parameters associated with a promotional period can be determined as 24 months instead of 12 months. This is because the 24-month period may have a higher probability of enticing the user to perform and satisfy the corresponding conditions. In some instances, to determine the condition parameters, the incentive-management application applies a machine-learning model to profile data of a user associated with the account.

The incentive-management application determines an alternative installment option associated with the account. The alternative installment option can identify a second recurring transfer of resources across the time period. In addition, the alternative installment option can be associated with an incentive associated with the account, in which the incentive can be applied when the one or more conditions are satisfied. Continuing with the example, if the user transfers an entirety of the resources within 24 months instead of the 48 months indicated in the default installment option, the resource provider can provide an incentive of waiving the interest fees that would have been accrued on the resources associated with the account. In another example, if the user activates the automatic withdrawal for the recurring transfer, the resource provider can reduce an interest rate associated with the default installment option from 24.99% to 22.99%. The reduction of interest rate can reduce the total amount interest that would have been added to the initial amount of the resources associated with the account. Additionally or alternatively, multiple incentives can be applied to the alternative installment options based on satisfaction of a single condition or multiple conditions. For example, the alternative installment option can include: (i) a first incentive indicating a reduction of 24.99% to 22.99% if the automatic withdrawal is activated; and (ii) a second incentive indicating waiver of interest fees if the resources are returned within 24 months of enrollment. In some instances, the incentive-management application performs a credit inquiry (e.g., a soft credit check) to determine whether the user can qualify for the alternative installment option that includes the incentives.

In some instances, various aspects of the incentive are configured by applying the machine-learning model to profile data of the user associated with the account. For example, the incentive can be associated with a particular type (e.g., waived interest, reduced interest rate, gifting promotional items), in which the type of incentives can be determined by applying a machine-learning model to the browsing history, posted messages, and previous purchases that are associated with the user. In addition, the incentive can include one or more incentive parameters, which can be determined by applying the machine-learning model to the profile data of the user. For example, the incentive parameters can identify a percentage of interest (e.g., 75%) to be waived if the conditions are satisfied, or a number of promotional items to be provided to the user if the conditions are satisfied.

The incentive-management application can transmit the installment option and the alternative installment option to a web service. When the installment option and the alternative installment option are received, the web service can cause the installment option and the alternative installment option to be displayed on one or more web pages. A user device can access the one or more web pages displayed on a browser to view and evaluate different installment options for returning the resources. Continuing with the example, the web service can display the default installment option indicating recurring transfer of resources over 48 months at 24.99% annual percentage rate, and an alternative installment option indicating recurring transfer of resources over 24 months with waived interest fees. A graphical user-interface element can be associated with a corresponding installment option, to allow the user to select one of the installment options for enrollment.

The incentive-management application can receive a user selection of the alternative installment option. In response to the user selection, the incentive-management application can enroll the user to the alternative installment option. Once enrolled, the incentive-management application can monitor actions performed by the user to determine whether the conditions specified in the alternative installment option have been satisfied. Continuing with the example, the incentive-management application can receive the user selection of the alternative installment option that involves recurring transfer of resources for 24 months with waived interest fees. The resource-management can then enroll the user to the alternative installment option and monitor whether the user transferred the entirety of the borrowed resources within 24 months.

The incentive-management application can detect in real-time a set of actions performed for the account. In some instances, the set of actions are detected in real-time as a plurality of actions continue to be performed for the account. In some instances, the non-static, real-time detection can result in the set of actions at a particular time point being different from other sets of actions that are detected in different time points (e.g., 10 seconds later, 30 seconds later, 1 minute later, 5 minutes later, 10 minutes later). The set of actions can be associated with the one or more conditions. Continuing with the example, the incentive-management application can detect that the recurring transfer of resources has been performed. In another example, the incentive-management application can detect that the automatic withdrawal has been activated for the account.

The incentive-management application determines in real-time that the one or more conditions have been satisfied based on the set of actions. In some instances, the one or more conditions are determined to have been satisfied in real-time as the plurality of actions continue to be performed for the account. In some instances, the non-static, real-time determination can result in the outcomes being different from outcomes determined at different time points (e.g., 10 seconds before the time point, 5 minutes after the time point) at which the set of actions may yet to satisfy or no longer satisfy the one or more conditions. Continuing with the example, the incentive-management application can continue to reduce the account balance with resources transferred each month. Once the account balance reduces to zero, the incentive-management application can identify a date at which the account balance became zero and compare the identified date with a date associated with the conditions (e.g., 24-month promotional date). If the identified date has occurred earlier than the 24-month promotional date, the incentive-management application can determine that the conditions have been satisfied.

The incentive-management application can process the incentive associated with the alternative installment option. Continuing with the example, the incentive-management application can reduce the interest rate to 22.99% after determining that the automatic withdrawal has been activated by the user. In another example, the incentive-management application can waive the interest fees from the account balance or can refund any transferred interest fees back to the user.

### I. Techniques for Determining Conditions and Incentives Associated With Installment Options

### A. Example Implementation

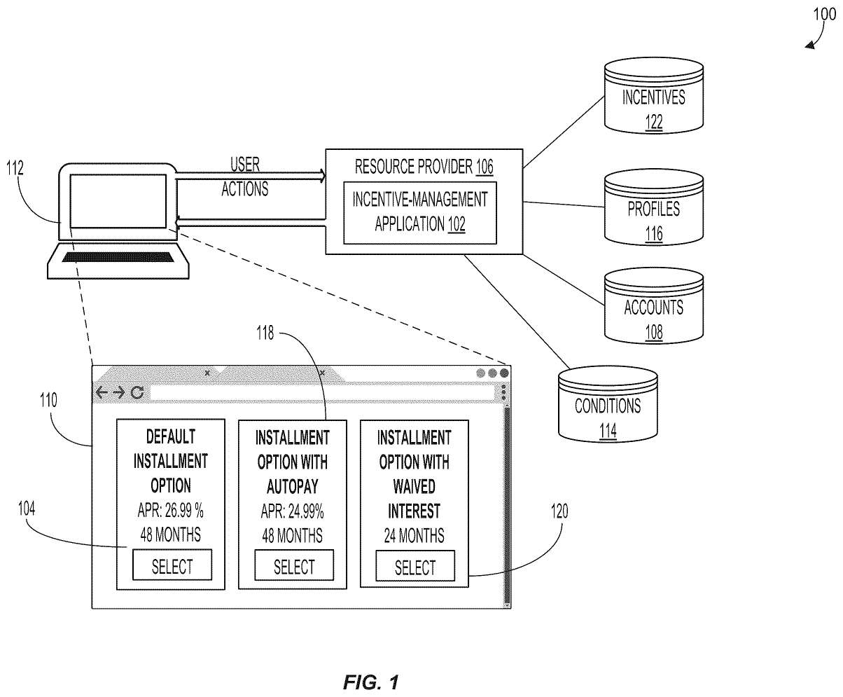

FIG. 1 illustrates an example schematic diagram 100 for determining conditions and incentives associated with installment options, according to some embodiments. The example schematic diagram 100 shows an incentive-management application 102 identifying a default installment option 104 associated with an account. The installment option 104 can identify a first recurring transfer of resources across a time period. In some instances, the resources were provided by a resource provider 106 to complete a particular transaction for a user. By providing the resources, the resource provider 106 can activate an account associated with the borrowed resources and store the account data in an account database 108. To return the resources of the account, the user can be enrolled in the installment option 104, which indicates a recurring transfer of a portion of the resources over 48 months. In addition, the installment option can be associated an interest to be added to the resources. The interest can be determined based on a percentage of the borrowed resources (e.g., an interest rate). For the installment option 104, the interest can be determined based on 26.99% annual percentage rate (APR) of the resources associated with the account. The installment option 104 can be displayed by a browser 110 of a user device 112.

To facilitate return of the resources, the resource provider 106 can provide various incentives when certain conditions are satisfied. In particular, the incentive-management application 102 can determine one or more conditions associated with transferring the resources. The conditions can specify certain actions to be performed for the account. When the conditions are satisfied based on the performed actions, the resource provider can provide the incentives for the account. In some instances, a set of conditions are generated and stored in a database 114, at which the incentive-management application 102 can access the one or more conditions for the account. As shown in FIG. 1, the one or more conditions can include transferring the entirety of resources associated with the account before 24 months, instead of the default maturation date of 48 months. Similarly, the one or more conditions can include activating an automatic withdrawal of the resources (e.g., autopay) associated with the account.

The conditions can be associated with corresponding parameters. The condition parameters can be adjusted to entice the user to perform actions associated with the conditions and thereby facilitate the satisfaction of the conditions. For example, the condition parameters associated with waiving interest can be determined as 24 months. This is because the 24-month period may have a higher probability of enticing the user to perform and satisfy the corresponding conditions. In some instances, the incentive-management application 102 accesses the conditions and their respective parameters from the conditions database 114.

The incentive-management application 102 can determine the conditions and their respective parameters based on the account of the user. For example, the incentive-management application 102 can retrieve an account identifier associated with the account from the accounts database 108 and submit a query to the conditions database 114 to access the conditions associated with the account identifier. In some instances, the incentive-management application 102 applies a machine-learning model to profile data accessed from a profiles database 116 to determine the condition parameters. Once the machine-learning model determines the condition parameters, the incentive-management application 102 can store the conditions and their respective condition parameters in the conditions database 114.

The incentive-management application 102 can determine an alternative installment option associated with the account. The alternative installment option can identify a second recurring transfer of resources across the time period. In addition, the alternative installment option can be associated with an incentive associated with the account, in which the incentive can be applied to the account when the one or more conditions are satisfied. For example, a first alternative installment option 118 can include an incentive relating to a reduction of the interest rate from 26.99% to 24.99%. The first alternative installment option 118 can specify that the corresponding incentive is triggered if autopay withdrawal is activated by the user. In another example, a second alternative installment option 120 can include an incentive relating to a waiver of interest fees. The second alternative installment option 120 can specify that the corresponding incentive is triggered if the user transfers an entirety of the resources within 24 months instead of the 48 months indicated in the default installment option 104. In some instances, multiple incentives are applied to the alternative installment options based on satisfaction of a single condition or multiple conditions. For example, an alternative installment option (not shown) can include: (i) a first incentive indicating a reduction of 26.99% to 25.99% if the automatic withdrawal is activated; and (ii) a second incentive indicating waiver of interest fees if the resources are returned within 24 months of enrollment. In some instances, the incentive-management application 102 performs a credit inquiry (e.g., a soft credit check) to determine whether the user can qualify for the alternative installment option that includes the incentives.

The incentive-management application 102 can also determine the incentives and their respective parameters based on account data of the user. For example, the incentive-management application 102 can retrieve an account identifier associated with the account from the accounts database 108 and submit a query to the incentives database 122 to access the incentives associated with the account identifier. The incentive-management application 102 can then associate the incentives with the alternative installment option. In some instances, an incentive type is determined by applying the machine-learning model to the profile data accessed from the profiles database 116. For example, the incentive can be associated with a particular type (e.g., waived interest, reduced interest rate, gifting promotional items), in which the incentive-management application 102 can determine the type of incentives by applying a machine-learning model to the browsing history, posted messages, and previous purchases that are associated with the user.

In addition, the incentive-management application 102 can also determine parameters of the incentives by applying the machine-learning model to the profile data of the user. For example, the incentive parameters can identify a percentage of interest (e.g., 75%) to be waived if the conditions are satisfied, or a number of promotional items to be provided to the user if the conditions are satisfied. Once the machine-learning model is used to determine the incentives and their respective parameters, the incentive-management application 102 can store the incentives and their respective parameters in the incentives database 122.

The incentive-management application 102 can transmit the installment option 104 and the alternative installment options 118 and 120 to be displayed on the web browser 110 or on a display page of another application (not shown). In some instances, the incentive-management application 102 transmits the installment option 104 and the alternative installment options 118 and 120 to a web service (e.g., a merchant), at which the web service causes the installment options to be displayed on its corresponding web pages. The user can utilize the user device 112 to access the one or more web pages displayed on the browser 110, at which the user can view and evaluate the different installment options 104, 118, and 120 for returning the resources. With reference to FIG. 1, the browser 110 can display the default installment option 104 indicating recurring transfer of resources over 48 months at 26.99% annual percentage rate, the first alternative installment option 118 indicating an incentive of 24.99% annual percentage rate once autopay is activated, and the second alternative installment option 120 indicating an incentive of interest waiver once the resources are transferred within 24 months. A graphical user-interface element can be associated with a corresponding installment option. With reference to FIG. 1, the buttons “SELECT” can be associated with the respective installment options 104, 118, and 120 to allow the user to select one of the installment options for enrollment.

The incentive-management application 102 can receive a user selection of the alternative installment option 120. In response to the user selection, the incentive-management application can enroll the user to the alternative installment option 120. Once enrolled, the incentive-management application 102 can monitor actions performed by the user to determine whether the conditions specified in the alternative installment option 120 have been satisfied. Continuing with the example, the incentive-management application 102 can receive the user selection of the alternative installment option 120 that involves recurring transfer of resources for 24 months with waived interest fees. The resource-management can then enroll the user to the alternative installment option 120 and monitor whether the user transferred the entirety of the borrowed resources within 24 months.

The incentive-management application 102 can detect in real-time a set of actions performed for the account. In some instances, the set of actions are detected in real-time as a plurality of actions continue to be performed for the account. In some instances, the non-static, real-time detection can result in the set of actions at a particular time point being different from other sets of actions that are detected in different time points (e.g., 10 seconds later, 30 seconds later, 1 minute later, 5 minutes later, 10 minutes later). The set of actions can be associated with the one or more conditions. For example, the incentive-management application 102 can detect that a portion of resources has been transferred or an autopay withdrawal has been activated based on the set of actions performed by the user device 112.

The incentive-management application 102 can determine in real-time that the one or more conditions have been satisfied based on the set of actions. In some instances, the one or more conditions are determined to have been satisfied in real-time as the plurality of actions continue to be performed for the account. In some instances, the non-static, real-time determination can result in the outcomes being different from outcomes determined at different time points (e.g., 10 seconds before the time point, 5 minutes after the time point) at which the set of actions may yet to satisfy or no longer satisfy the one or more conditions. For example, the incentive-management application 102 detects that the autopay withdrawal has been activated. Since the alternative installment option 120 does not include a condition associated with the autopay withdrawal, the incentive-management application 102 does not take any further action. Continuing with the example, the incentive-management application 102 can continue to reduce the account balance with resources transferred by the user each month. Once the account balance reduces to zero, the incentive-management application 102 can identify a date at which the account balance became zero and compare the identified date with a date associated with the conditions (e.g., 24-month promotional date). If the identified date has occurred earlier than the 24-month promotional date, the incentive-management application 102 can determine that the conditions associated with the alternative installment option 120 have been satisfied.

The incentive-management application 102 can then process the incentive associated with the alternative installment option 120. With reference to FIG. 1, the incentive-management application 102 can waive the interest fees from the account balance. In some instances, the incentive-management application 102 transmits a notification to the user device 112 indicating that the incentive has been applied to the user account.

### B. System Components for Determining Conditions and Incentives Associated With Installment Options

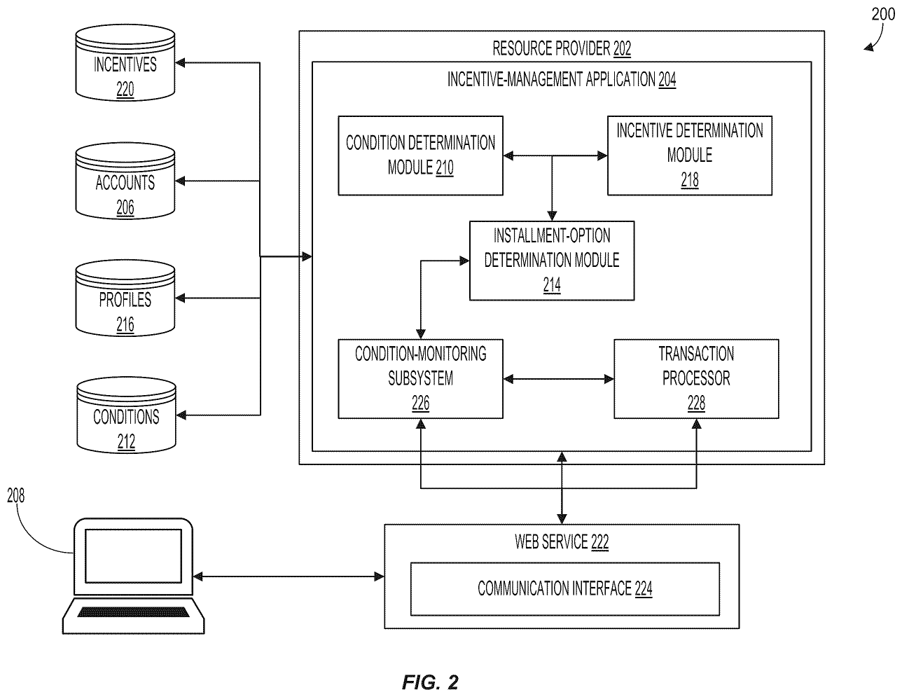

FIG. 2 illustrates an example computing environment 200 for determining conditions and incentives associated with installment options, according to some embodiments. In the computing environment 200, a resource provider 202 can provide an incentive-management application 204 configured to determine conditions and incentives associated with installment option associated with an account of a user. An installment option can identify a recurring transfer of resources across a time period. The resources can include any tangible or intangible assets that can be used to perform a transaction, such as obtaining a particular item or service. The recurring transfer can include transferring a portion of resources for every time interval within the time period. For example, if a total amount of borrowed resources equals to $480, a corresponding recurring transfer can include a monthly payment of $10 for 48 months. The recurring transfer can thus include a weekly transfer of resources, a biweekly transfer of resources, a monthly transfer of resources, a bimonthly transfer of resources, a transfer of resources every 6 months, an annual transfer of resources, or a biannual transfer of resources. The time period can include a predetermined time period for returning the resources, including 3 months, 6 months, 12 months, 18 months, 24 months, 30 months, 36 months, 42 months, 48 months, 60 months, or 72 months. The time period can be predetermined by the resource provider 202.

In some instances, the resources were previously provided by a resource provider to complete a particular transaction for the user. The transaction can include any interaction in which a user exchanges resources with another entity to obtain goods or services. After providing the resources, the resource provider 202 can activate an account associated with the borrowed resources and store the account data in an account database 206. The account data can include an account identifier, the borrowed resources, an installment option determined for the resources, and other types information that can be used to identify the user, including personally-identifiable information (PII) of a user, including name, address, age, social security number, credit score, date and place of birth, mother's maiden name, or biometric records associated with the user. The incentive-management application 204 can access the account data to determine conditions and incentives for an installment option.

As noted above, the user can be associated with a corresponding installment option (e.g., a recurring transfer of a portion of the resources over 48 months). In addition, the installment option can be associated an interest to be added to the resources. The interest can be determined based on a percentage of the borrowed resources (e.g., an interest rate). For example, the interest can be determined based on 26.99% annual percentage rate (APR) of the resources associated with the account. An example interest rate can be determined from a range between 0.1% and 39.99%.

The installment option can be displayed by a browser of a user device 208. In some instances, the user device 208 can be a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these.

To facilitate return of the resources, the incentive-management application 204 can include various modules or components for providing incentives when certain conditions are satisfied. In particular, the incentive-management application 204 can include a condition determination module 210, which can be configured to determine one or more conditions associated with transferring the resources. The conditions can include certain actions to be performed for the account to qualify for the corresponding incentives. Examples of the conditions can include, but are not limited to, payment of at least a portion of resources within a shorter time period (e.g., 24 months instead of 48 months), enrolling for autopay withdrawal, initial payment of a percentage (e.g., 20%) of resources during enrollment of the installment option, on-time payments over the entire time period (e.g., no late payment, no defaults), and recurring transfer of higher amount of resources relative to an amount specified in the default installment option.

When the incentive-management application 204 determines that the actions satisfy the conditions, the resource provider 202 can provide the incentives for the account. In some instances, the incentive-management application 204 can generate and store a set of conditions in a conditions database 212 (e.g., based on user input), at which the condition determination module 210 can access the one or more conditions through the conditions database 212. As an illustrative example, the one or more conditions can include transferring the entirety of resources associated with the account before 24 months, instead of the default maturation date of 48 months. Similarly, the one or more conditions can include activating an automatic withdrawal of the resources (e.g., autopay) associated with the account.

The conditions can be associated with corresponding parameters. The condition parameters can include any metrics for which the user has to meet or exceed in order to satisfy the conditions. For example, if the condition includes transferring the resources within a shorter time period, the corresponding parameter can be 24 months instead of the default parameter which is 48 months. The condition parameters can be adjusted to entice the user to perform actions associated with the conditions and thereby facilitate the satisfaction of the conditions. In some instances, the condition determination module 210 accesses the conditions and their respective parameters from the conditions database 212, at which the parameters can be adjusted to optimize the process of providing the incentives.

The condition determination module 210 can determine the conditions and their respective parameters based on the account of the user. For example, the condition determination module 210 can retrieve an account identifier associated with the account from the accounts database 206 and submit a query to the conditions database 212 to access the conditions associated with the account identifier. In some instances, the condition determination module 210 applies a machine-learning model to profile data of the user to determine the condition parameters. For example, the condition determination module 210 can access the profile data from a profiles database 216 and apply the accessed profile data to the machine-learning model to determine condition parameters. Once the machine-learning model determines the condition parameters, the incentive-management application can update and store the conditions and their respective condition parameters in the conditions database 212.

The profile data can include various types of data associated with the user. Similar to account data, the profile data can include PII of the user, including name, address, age, social security number, credit score, date and place of birth, mother's maiden name, or biometric records associated with the user. In some instances, the profile data does not include sensitive PII (e.g., social security numbers), to protect the user's privacy. In addition to the PII, the profile data can include data that indicates interactions or activities performed by the user, including interactions with the resource provider 202. For example, the profile data can include browsing history, posted messages, previous purchases that are associated with the user, any previous transfer of resources associated with the resource provider, any user accounts that are currently open, any user accounts that are currently closed, and other clickstream data. The profile data can be obtained and stored in the profiles database 216 in real-time, as the activities and interactions are being performed by the user. In effect, the condition determination module 210 can use the machine-learning model to determine the conditions and their respective parameters in real-time, as the output generated based on the profile data at a given time point would be different relative to other outputs generated at a different time point (e.g., after 1 minute, after 5 minutes, after 10 minutes, after 15 minutes).

As an illustrative example of the machine-learning model, the condition determination module 210 may implement a clustering algorithm to identify similarly situated user based on one or more vectors (e.g., outstanding debt, spending patterns, available funds in accounts associated with the user, an amount of resources requested, indication of default). In some instances, a dataset of the profile data associated with sample members (e.g., testers, etc.) may be analyzed using a clustering algorithm to identify different types of members that may be enrolled in the alternative installment option. Example clustering algorithms that may trained using sample member datasets (e.g., historical member data, hypothetical member data, etc.) to classify a member in order to determine condition parameters may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine-learning model generated using the profile data, the condition determination module 210 may determine the parameters to be assigned for the corresponding conditions.

Other examples of machine-learning or artificial intelligence algorithms can also be used by the condition determination module 210. For example, the machine-learning model may be any time of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. As may be contemplated, the terms “machine learning” and “artificial intelligence” are frequently used interchangeably due to the degree of overlap between these fields and many of the disclosed techniques and algorithms have similar approaches.

In some instances, the machine-learning model is trained based on a loss (e.g., a cross-entropy loss) determined between the generated condition parameters and subsequent satisfaction of the corresponding conditions. For example, parameters of a machine-learning model (e.g., an artificial neural network) can be learned by processing the condition parameters and corresponding outcomes via a loss function (e.g., softmax function). Additionally or alternatively, the machine-learning model can be trained based on whether the user has selected the alternative installment option based on the respective condition parameters. As a result, the machine-learning models can be optimized to generate the condition parameters that can entice the user to select the corresponding alternative installment option, as well as increasing the likelihood of the user satisfying the conditions to qualify for the incentives.

Based on the determined conditions, an installment-option determination module 214 of the incentive-management application 204 can determine an alternative installment option associated with the account. The alternative installment option can identify a second recurring transfer of resources across the time period. The alternative installment option can thus include aspects of recurring transfer (e.g., amount being transferred, the time period for which the resources need to be transferred, interest rate) that are different from those of the default installment option. The user can thus enroll to one of the default installment option or the alternative installment option to return the borrowed resources.

In addition, the alternative installment option can be associated with an incentive associated with the account, in which the incentive can be applied to the account when the one or more conditions are satisfied. Incentives can include any tangible or intangible benefits provided to the user to facilitate return of the resources to the resource provider 202. Examples of incentives can include, but are not limited to, reduction of interest fees from the to-be-returned resources, waiver of interest fees, any items or resources that can be used with other service providers (e.g., gift certificates, mileage points), any service that can be obtained from other service providers (e.g., gym membership, airport lounge membership, premium rental car membership), and any discount to resources associated with other goods or services.

The installment-option determination module 214 can communicate with an incentive determination module 218 to identify the incentives for the corresponding alternative installment option. In some instances, the installment-option determination module 214 can identify multiple incentives for the alternative installment option based on satisfaction of a single condition or multiple conditions. For example, an alternative installment option can include: (i) a first incentive indicating a reduction of 26.99% to 25.99% if the automatic withdrawal is activated; and (ii) a second incentive indicating waiver of interest fees if the resources are returned within 24 months of enrollment. In some instances, the incentive-management application performs a credit inquiry (e.g., a soft credit check) to determine whether the user can qualify for the alternative installment option that includes the incentives. Multiple incentives can include, but are not limited to, 2, 3, 4, 5, 10, or more than 10 incentives.

The incentive determination module 218 can be configured to determine the incentives and their respective parameters based on account data of the user. For example, the incentive determination module 218 can retrieve an account identifier associated with the account from the accounts database 206 and submit a query to an incentives database 220 to access the incentives associated with the account identifier. The incentive determination module 218 can transmit the incentives to the installment-option determination module 214, which can then associate the incentives with the alternative installment option.

In some instances, the incentive determination module 218 can determine various types of incentives by applying the machine-learning model to the profile data of the user. The incentive can be associated with a particular type (e.g., waived interest, reduced interest rate, gifting promotional items), in which the incentive-management application can determine the type of incentives by applying a machine-learning model to the browsing history, posted messages, and previous purchases that are associated with the user, in which the input data were accessed from the profiles database 216. In some instances, the incentive determination module 218 can access the profile data from the profiles database 216 and apply the accessed profile data to the machine-learning model to determine the types of incentives.

As described herein, the profile data can include, but are not limited to, the PII of the user, browsing history, posted messages, previous purchases that are associated with the user, any previous transfer of resources associated with the resource provider, any user accounts that are currently open, any user accounts that are currently closed, and other clickstream data. The machine-learning model for generating the types of incentives may be any time of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. In some instances, the machine-learning model for determining incentives (and their corresponding parameters) is different from the machine-learning model used for determining condition parameters.

In addition, the incentive determination module 218 can also determine parameters of the incentives by applying the machine-learning model to the profile data accessed from the profiles database 216. The incentive parameters can include any amount of tangible or intangible benefits for which the user can receive if the conditions are satisfied. For example, the incentive parameters can identify a percentage of interest (e.g., 75%) to be waived if the conditions are satisfied, or a number of promotional items to be provided to the user if the conditions are satisfied. Another example of the incentive parameters can include 12 months of gym membership or 20% discount to certain restaurants or retailers. Once the machine-learning model is used to determine the incentives and their respective parameters, the incentive-management application can store the incentives and their respective parameters in the incentives database.

Once the installment options are determined, the incentive-management application 204 can transmit the installment option and the alternative installment options and to be displayed on the web browser of the user device 208. In some instances, the incentive-management application 204 transmits the installment option and the alternative installment options and to a web service 222 (e.g., a merchant), at which a communication interface 224 of the web service 222 causes the installment options to be displayed on its corresponding web pages of the user device 208. The user can utilize the user device 208 to access the one or more web pages displayed on the browser, at which the user can view and evaluate the different installment options, and for returning the resources. In some instances, a plurality of graphical user-interface elements can be associated with a corresponding installment option. For example, the buttons “SELECT” can be associated with the respective installment options, and to allow the user to select one of the installment options for enrollment.

The installment option and the alternative installment options can be transmitted via one or more communication networks. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device 308 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

The incentive-management application 204 can receive a user selection of the alternative installment option. The user selection can include any type of user interaction performed using a user interface that indicates the selection of the alternative installment option. For example, the user selection can include clicking a button shown on the web page, a hand gesture on a touch interface, a voice input indicating selection of the alternative installment option. For example, the web service 222 can receive the user section via the communication interface 224, determine that the alternative installment option was selected, and transmit an indication to the incentive-management application 204 that the alternative option was selected. In response to the user selection, the incentive-management application 204 can enroll the user to the alternative installment option. Once enrolled, a condition-monitoring subsystem 226 of the incentive-management application 204 can monitor in real-time actions performed by the user to determine in real-time whether the conditions specified in the alternative installment option have been satisfied. For example, the incentive-management application 204 can receive the user selection of the alternative installment option and enroll the user to the alternative installment option. Once the user is enrolled, the condition-monitoring subsystem 226 can monitor in real-time whether actions performed by the user satisfies the conditions specified in the alternative installment option.

The condition-monitoring subsystem 226 can also detect in real-time a set of actions performed for the account. Examples of the set of actions can include viewing an account balance of the account, transfer of resources to the resource provider 202, enrollment of services associated with the account including autopay withdrawal or opt-in to paperless statements, or any other types of activity that are performed after accessing the account of the user. In some instances, the condition-monitoring subsystem 226 detects the set of actions in real-time as a plurality of actions continue to be performed and monitored for the account. In some instances, the non-static, real-time detection can result in the set of actions at a particular time point being different from other sets of actions that are detected in different time points (e.g., 10 seconds later, 30 seconds later, 1 minute later, 5 minutes later, 10 minutes later). The set of actions can be associated with satisfying at least part of the one or more conditions. For example, the condition-monitoring subsystem 226 can detect that a portion of resources has been transferred to the account, or an autopay withdrawal has been activated based on the set of actions performed by the user device.

The condition-monitoring subsystem 226 can determine in real-time that the one or more conditions have been satisfied based on the set of actions. In some instances, the one or more conditions are determined to have been satisfied in real-time as the plurality of actions continue to be performed for the account. In some instances, the non-static, real-time determination can result in the outcomes being different from outcomes determined at different time points (e.g., 10 seconds before the time point, 5 minutes after the time point) at which the set of actions may yet to satisfy or no longer satisfy the one or more conditions. For example, the condition-monitoring subsystem 226 detects that the autopay withdrawal has been activated. Since the alternative installment option does not include a condition associated with the autopay withdrawal, the condition-monitoring subsystem 226 does not take any further action. Continuing with the example, the condition-monitoring subsystem 226 can continue to reduce the account balance with resources transferred by the user each month. Once the account balance reduces to zero, the condition-monitoring subsystem 226 can identify a date at which the account balance became zero and compare the identified date with a date associated with the conditions (e.g., 24-month promotional date). If the identified date has occurred earlier than the 24-month promotional date, the condition-monitoring subsystem 226 can determine that the conditions associated with the alternative installment option have been satisfied. In some instances, the condition-monitoring subsystem 226 can generate a notification that the conditions have been satisfied.

A transaction processor 228 of the incentive-management application 204 can then process the incentive associated with the alternative installment option. In some instances, the transaction processor 228 receives the notification generated by the condition-monitoring subsystem 226 indicating that the conditions have been satisfied. The transaction processor 228 can update the account data of the user by accessing the account data from the accounts database 206, update the account data by applying the incentives to the resources (e.g., adjust interest fees), and store the updated account data in the accounts database 206. For example, the transaction processor 228 can waive the interest fees from the account balance. In another example, the incentive-management application 204 can transmit in real-time discount codes or gift certificates corresponding to the incentives, once the conditions are satisfied. In some instances, the transaction processor 228 transmits a notification to the user device 208 indicating that the incentive has been applied to the user account.

### C. System Components and Special-Purpose Computer for Determining Conditions and Incentives Associated With Installment Options

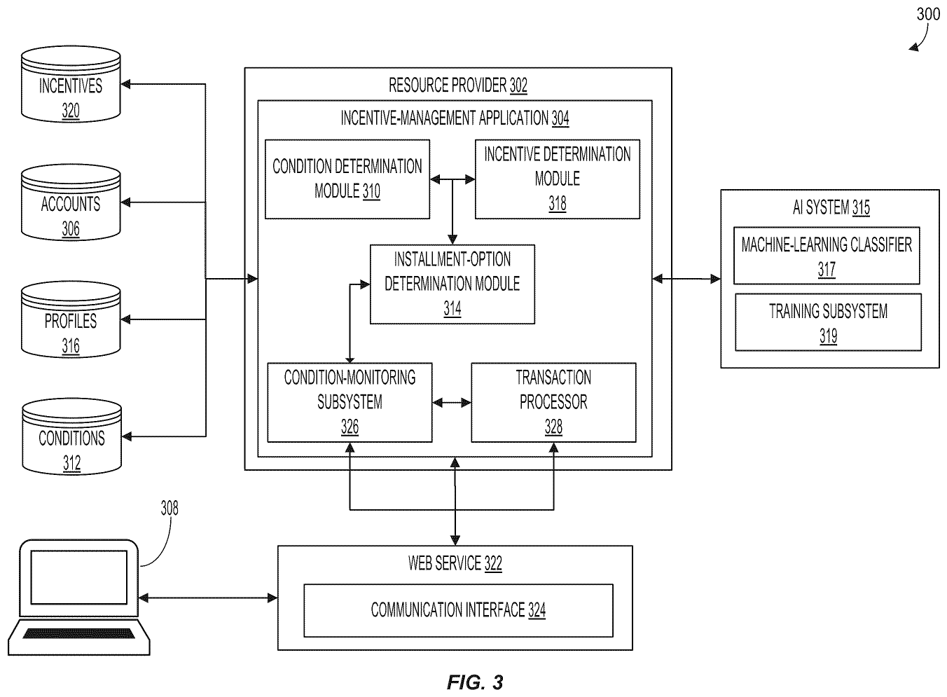

FIG. 3 illustrates an example computing environment 300 that includes a special-purpose computer configured to determine conditions and incentives associated with installment options, according to some embodiments. In the computing environment 300, a resource provider 302 can provide an incentive-management application 304 configured to determine conditions and incentives associated with installment option associated with an account of a user. An installment option can identify a recurring transfer of resources across a time period. The resources can include any tangible or intangible assets that can be used to perform a transaction, such as obtaining a particular item or service. The recurring transfer can include transferring a portion of resources for every time interval within the time period. For example, if a total amount of borrowed resources equals to $480, a corresponding recurring transfer can include a monthly payment of $10 for 48 months. The recurring transfer can thus include a weekly transfer of resources, a biweekly transfer of resources, a monthly transfer of resources, a bimonthly transfer of resources, a transfer of resources every 6 months, an annual transfer of resources, or a biannual transfer of resources. The time period can include a predetermined time period for returning the resources, including 3 months, 6 months, 12 months, 18 months, 24 months, 30 months, 36 months, 42 months, 48 months, 60 months, or 72 months. The time period can be predetermined by the resource provider 302.

In some instances, the resources were previously provided by a resource provider to complete a particular transaction for the user. The transaction can include any interaction in which a user exchanges resources with another entity to obtain goods or services. After providing the resources, the resource provider 302 can activate an account associated with the borrowed resources and store the account data in an account database 306. The account data can include an account identifier, the borrowed resources, an installment option determined for the resources, and other types information that can be used to identify the user, including personally-identifiable information (PII) of a user, including name, address, age, social security number, credit score, date and place of birth, mother's maiden name, or biometric records associated with the user. The incentive-management application 304 can access the account data to determine conditions and incentives for an installment option.

As noted above, the user can be associated with a corresponding installment option (e.g., a recurring transfer of a portion of the resources over 48 months). In addition, the installment option can be associated an interest to be added to the resources. The interest can be determined based on a percentage of the borrowed resources (e.g., an interest rate). For example, the interest can be determined based on 26.99% annual percentage rate (APR) of the resources associated with the account. An example interest rate can be determined from a range between 0.1% and 39.99%.

The installment option can be displayed by a browser of a user device 308. In some instances, the user device 308 can be a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these.

To facilitate return of the resources, the incentive-management application 304 can include various modules or components for providing incentives when certain conditions are satisfied. In particular, the incentive-management application 304 can include a condition determination module 310, which can be configured to determine one or more conditions associated with transferring the resources. The conditions can include certain actions to be performed for the account to qualify for the corresponding incentives. Examples of the conditions can include, but are not limited to, payment of at least a portion of resources within a shorter time period (e.g., 24 months instead of 48 months), enrolling for autopay withdrawal, initial payment of a percentage (e.g., 20%) of resources during enrollment of the installment option, on-time payments over the entire time period (e.g., no late payment, no defaults), and recurring transfer of higher amount of resources relative to an amount specified in the default installment option.

When the incentive-management application 304 determines that the actions satisfy the conditions, the resource provider 302 can provide the incentives for the account. In some instances, the incentive-management application 304 can generate and store a set of conditions in a conditions database 312 (e.g., based on user input), at which the condition determination module 310 can access the one or more conditions through the conditions database 312. As an illustrative example, the one or more conditions can include transferring the entirety of resources associated with the account before 24 months, instead of the default maturation date of 48 months. Similarly, the one or more conditions can include activating an automatic withdrawal of the resources (e.g., autopay) associated with the account.

The conditions can be associated with corresponding parameters. The condition parameters can include any metrics for which the user has to meet or exceed in order to satisfy the conditions. For example, if the condition includes transferring the resources within a shorter time period, the corresponding parameter can be 24 months instead of the default parameter which is 48 months. The condition parameters can be adjusted to entice the user to perform actions associated with the conditions and thereby facilitate the satisfaction of the conditions. In some instances, the condition determination module 310 accesses the conditions and their respective parameters from the conditions database 312, at which the parameters can be adjusted to optimize the process of providing the incentives.

The condition determination module 310 can determine the conditions and their respective parameters based on the account of the user. For example, the condition determination module 310 can retrieve an account identifier associated with the account from the accounts database 306 and submit a query to the conditions database 312 to access the conditions associated with the account identifier.

In some instances, the condition determination module 310 applies a machine-learning model to profile data of the user to determine the condition parameters. For example, the condition determination module 310 can access the profile data from a profiles database 316 and apply the accessed profile data to the machine-learning model to determine condition parameters. In another example, the condition determination module 310 can transmit the profile data to an AI system 315, which can apply the machine-learning model to the accessed profile data to generate the condition parameters. In some embodiments, the AI system 315 is implemented by a special purpose computer that is specifically configured to process the profile data and generate outputs that can be used to determine conditions and incentives associated with various installment options. Additionally, one or more components of the AI system 315 can be implemented by another special purpose computer (e.g., a training subsystem 319), which can be specifically configured to train the machine-learning model using profile data of other users and applying the trained machine-learning algorithms. The AI system 315 can generate the condition parameters in real-time using the machine-learning model, as the AI system 315 continues to receive profile data associated with various users. The non-static, real-time features of using the machine-learning algorithms may result in condition parameters at a particular time point being different from other condition parameters determined at different time points (e.g., after 10 seconds, after 1 minute, after 5 minutes, after 30 minutes). Once the machine-learning model determines the condition parameters, the incentive-management application 304 can update and store the conditions and their respective condition parameters in the conditions database 312.

The profile data processed by the AI system 315 can include various types of data associated with the user. Similar to account data, the profile data can include PII of the user, including name, address, age, social security number, credit score, date and place of birth, mother's maiden name, or biometric records associated with the user. In some instances, the profile data does not include sensitive PII (e.g., social security numbers), to protect the user's privacy. In addition to the PII, the profile data can include data that indicates interactions or activities performed by the user, including interactions with the resource provider 302. For example, the profile data can include browsing history, posted messages, previous purchases that are associated with the user, any previous transfer of resources associated with the resource provider, any user accounts that are currently open, any user accounts that are currently closed, and other clickstream data. The profile data can be obtained and stored in the profiles database 316 in real-time, as the activities and interactions are being performed by the user. In effect, the condition determination module 310 can use the machine-learning model to determine the conditions and their respective parameters in real-time, as the output generated based on the profile data at a given time point would be different relative to other outputs generated at a different time point (e.g., after 1 minute, after 5 minutes, after 10 minutes, after 15 minutes).

As an illustrative example of using the machine-learning model, a machine-learning classifier 317 of the AI system 315 may implement a clustering algorithm to identify similarly situated user based on one or more vectors (e.g., outstanding debt, spending patterns, available funds in accounts associated with the user, an amount of resources requested, indication of default). In some instances, a dataset of the profile data associated with sample members (e.g., testers, etc.) may be analyzed using a clustering algorithm to identify different types of members that may be enrolled in the alternative installment option. Example clustering algorithms that may trained using sample member datasets (e.g., historical member data, hypothetical member data, etc.) to classify a member in order to determine condition parameters may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine-learning model generated using the profile data, the condition determination module 310 may determine the parameters to be assigned for the corresponding conditions.

Other examples of machine-learning or artificial intelligence algorithms can also be used by the AI system 315. For example, the machine-learning model may be any time of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. As may be contemplated, the terms “machine learning” and “artificial intelligence” are frequently used interchangeably due to the degree of overlap between these fields and many of the disclosed techniques and algorithms have similar approaches.

In some instances, a training subsystem 319 of the AI system 315 trains the machine-learning model based on a loss (e.g., a cross-entropy loss) determined between the generated condition parameters and subsequent satisfaction of the corresponding conditions. For example, parameters of a machine-learning model (e.g., an artificial neural network) can be learned by processing the condition parameters and corresponding outcomes via a loss function (e.g., softmax function). Additionally or alternatively, the training subsystem 319 can train the machine-learning model based on whether the user has selected the alternative installment option based on the respective condition parameters. As a result, the AI system 315 can optimize the machine-learning models to generate the condition parameters that can entice the user to select the corresponding alternative installment option, as well as increasing the likelihood of the user satisfying the conditions to qualify for the incentives.

Based on the determined conditions, an installment-option determination module 314 of the incentive-management application 304 can determine an alternative installment option associated with the account. The alternative installment option can identify a second recurring transfer of resources across the time period. The alternative installment option can thus include aspects of recurring transfer (e.g., amount being transferred, the time period for which the resources need to be transferred, interest rate) that are different from those of the default installment option. The user can thus enroll to one of the default installment option or the alternative installment option to return the borrowed resources.

In addition, the alternative installment option can be associated with an incentive associated with the account, in which the incentive can be applied to the account when the one or more conditions are satisfied. Incentives can include any tangible or intangible benefits provided to the user to facilitate return of the resources to the resource provider 302. Examples of incentives can include, but are not limited to, reduction of interest fees from the to-be-returned resources, waiver of interest fees, any items or resources that can be used with other service providers (e.g., gift certificates, mileage points), any service that can be obtained from other service providers (e.g., gym membership, airport lounge membership, premium rental car membership), and any discount to resources associated with other goods or services.

The installment-option determination module 314 can communicate with an incentive determination module 318 to identify the incentives for the corresponding alternative installment option. In some instances, the installment-option determination module 314 can identify multiple incentives for the alternative installment option based on satisfaction of a single condition or multiple conditions. For example, an alternative installment option can include: (i) a first incentive indicating a reduction of 26.99% to 25.99% if the automatic withdrawal is activated; and (ii) a second incentive indicating waiver of interest fees if the resources are returned within 24 months of enrollment. In some instances, the incentive-management application performs a credit inquiry (e.g., a soft credit check) to determine whether the user can qualify for the alternative installment option that includes the incentives. Multiple incentives can include, but are not limited to, 2, 3, 4, 5, 10, or more than 10 incentives.

The incentive determination module 318 can be configured to determine the incentives and their respective parameters based on account data of the user. For example, the incentive determination module 318 can retrieve an account identifier associated with the account from the accounts database 306 and submit a query to an incentives database 320 to access the incentives associated with the account identifier. The incentive determination module 318 can transmit the incentives to the installment-option determination module 314, which can then associate the incentives with the alternative installment option.

In some instances, the incentive determination module 318 can determine various types of incentives by applying the machine-learning model to the profile data of the user. For example, the incentive determination module 318 can access the profile data from the profiles database 316 and transmit the profile data to the AI system 315. When the profile data is received, the AI system 315 can apply a corresponding machine-learning model to the profile data to determine various types of incentives associated with the installment options. The incentive can be associated with a particular type (e.g., waived interest, reduced interest rate, gifting promotional items), in which the incentive-management application can determine the type of incentives by applying a machine-learning model to the browsing history, posted messages, and previous purchases that are associated with the user, in which the input data were accessed from the profiles database 316. In some instances, the incentive determination module 318 can access the profile data from the profiles database 316 and apply the accessed profile data to the machine-learning model to determine the types of incentives.

As described herein, the profile data can include, but are not limited to, the PII of the user, browsing history, posted messages, previous purchases that are associated with the user, any previous transfer of resources associated with the resource provider, any user accounts that are currently open, any user accounts that are currently closed, and other clickstream data. The machine-learning model used by the machine-learning classifier 317 for generating the types of incentives may be any time of machine-learning model such as, but not limited to, a classifier (e.g., single-variate or multivariate that is based on k-nearest neighbors, Naïve Bayes, Logistic regression, support vector machine, decision trees, an ensemble network of classifiers, and/or the like), regression model (e.g., such as, but not limited to, linear regressions, logarithmic regressions, Lasso regression, Ridge regression, and/or the like), clustering model (e.g., such as, but not limited to, models based on k-means, hierarchical clustering, DBSCAN, biclustering, expectation-maximization, random forest, and/or the like), deep learning model (e.g., such as, but not limited to, neural networks, convolutional neural networks, recurrent neural networks, long short-term memory (LSTM), multilayer perceptions, etc.), combinations thereof (e.g., disparate-type ensemble networks, etc.), or the like. In some instances, the machine-learning model for determining incentives (and their corresponding parameters) is different from the machine-learning model used for determining condition parameters.

In addition, the incentive determination module 318 can also determine parameters of the incentives by applying the machine-learning model to the profile data accessed from the profiles database 316. Similar to the above example, the incentive determination module 318 can access the profile data from the profiles database 316 and transmit the profile data to the AI system 315. When the profile data is received, the AI system 315 can apply a corresponding machine-learning model to the profile data to determine incentive parameters. The incentive parameters can include any amount of tangible or intangible benefits for which the user can receive if the conditions are satisfied. For example, the incentive parameters can identify a percentage of interest (e.g., 75%) to be waived if the conditions are satisfied, or a number of promotional items to be provided to the user if the conditions are satisfied. Another example of the incentive parameters can include 12 months of gym membership or 30% discount to certain restaurants or retailers. Once the machine-learning model is used to determine the incentives and their respective parameters, the incentive-management application can store the incentives and their respective parameters in the incentives database.

Once the installment options are determined, the incentive-management application 304 can transmit the installment option and the alternative installment options and to be displayed on the web browser of the user device 308. In some instances, the incentive-management application 304 transmits the installment option and the alternative installment options and to a web service 322 (e.g., a merchant), at which a communication interface 324 of the web service 322 causes the installment options to be displayed on its corresponding web pages of the user device 308. The user can utilize the user device 308 to access the one or more web pages displayed on the browser, at which the user can view and evaluate the different installment options, and for returning the resources. In some instances, a plurality of graphical user-interface elements can be associated with a corresponding installment option. For example, the buttons “SELECT” can be associated with the respective installment options, and to allow the user to select one of the installment options for enrollment.

The installment option and the alternative installment options can be transmitted via one or more communication networks. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device 308 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

The incentive-management application 304 can receive a user selection of the alternative installment option. The user selection can include any type of user interaction performed using a user interface that indicates the selection of the alternative installment option. For example, the user selection can include clicking a button shown on the web page, a hand gesture on a touch interface, a voice input indicating selection of the alternative installment option. For example, the web service 322 can receive the user section via the communication interface 324, determine that the alternative installment option was selected, and transmit an indication to the incentive-management application 304 that the alternative option was selected. In response to the user selection, the incentive-management application 304 can enroll the user to the alternative installment option. Once enrolled, a condition-monitoring subsystem 326 of the incentive-management application 304 can monitor in real-time actions performed by the user to determine in real-time whether the conditions specified in the alternative installment option have been satisfied. For example, the incentive-management application 304 can receive the user selection of the alternative installment option and enroll the user to the alternative installment option. Once the user is enrolled, the condition-monitoring subsystem 326 can monitor in real-time whether actions performed by the user satisfies the conditions specified in the alternative installment option.

The condition-monitoring subsystem 326 can also detect in real-time a set of actions performed for the account. Examples of the set of actions can include viewing an account balance of the account, transfer of resources to the resource provider 302, enrollment of services associated with the account including autopay withdrawal or opt-in to paperless statements, or any other types of activity that are performed after accessing the account of the user. In some instances, the condition-monitoring subsystem 326 detects the set of actions in real-time as a plurality of actions continue to be performed and monitored for the account. In some instances, the non-static, real-time detection can result in the set of actions at a particular time point being different from other sets of actions that are detected in different time points (e.g., 10 seconds later, 30 seconds later, 1 minute later, 5 minutes later, 10 minutes later). The set of actions can be associated with satisfying at least part of the one or more conditions. For example, the condition-monitoring subsystem 326 can detect that a portion of resources has been transferred to the account, or an autopay withdrawal has been activated based on the set of actions performed by the user device.

The condition-monitoring subsystem 326 can determine in real-time that the one or more conditions have been satisfied based on the set of actions. In some instances, the one or more conditions are determined to have been satisfied in real-time as the plurality of actions continue to be performed for the account. In some instances, the non-static, real-time determination can result in the outcomes being different from outcomes determined at different time points (e.g., 10 seconds before the time point, 5 minutes after the time point) at which the set of actions may yet to satisfy or no longer satisfy the one or more conditions. For example, the condition-monitoring subsystem 326 detects that the autopay withdrawal has been activated. Since the alternative installment option does not include a condition associated with the autopay withdrawal, the condition-monitoring subsystem 326 does not take any further action.

Continuing with the example, the condition-monitoring subsystem 326 can continue to reduce the account balance with resources transferred by the user each month. Once the account balance reduces to zero, the condition-monitoring subsystem 326 can identify a date at which the account balance became zero and compare the identified date with a date associated with the conditions (e.g., 24-month promotional date). If the identified date has occurred earlier than the 24-month promotional date, the condition-monitoring subsystem 326 can determine that the conditions associated with the alternative installment option have been satisfied. In some instances, the condition-monitoring subsystem 326 can generate a notification that the conditions have been satisfied.

A transaction processor 328 of the incentive-management application 304 can then process the incentive associated with the alternative installment option. In some instances, the transaction processor 328 receives the notification generated by the condition-monitoring subsystem 326 indicating that the conditions have been satisfied. The transaction processor 328 can update the account data of the user by accessing the account data from the accounts database 306, update the account data by applying the incentives to the resources (e.g., adjust interest fees), and store the updated account data in the accounts database 306. For example, the transaction processor 328 can waive the interest fees from the account balance. In another example, the incentive-management application 304 can transmit in real-time discount codes or gift certificates corresponding to the incentives, once the conditions are satisfied. In some instances, the transaction processor 328 transmits a notification to the user device 308 indicating that the incentive has been applied to the user account.

### II. Methods for Determining Conditions and Incentives Associated With Installment Options

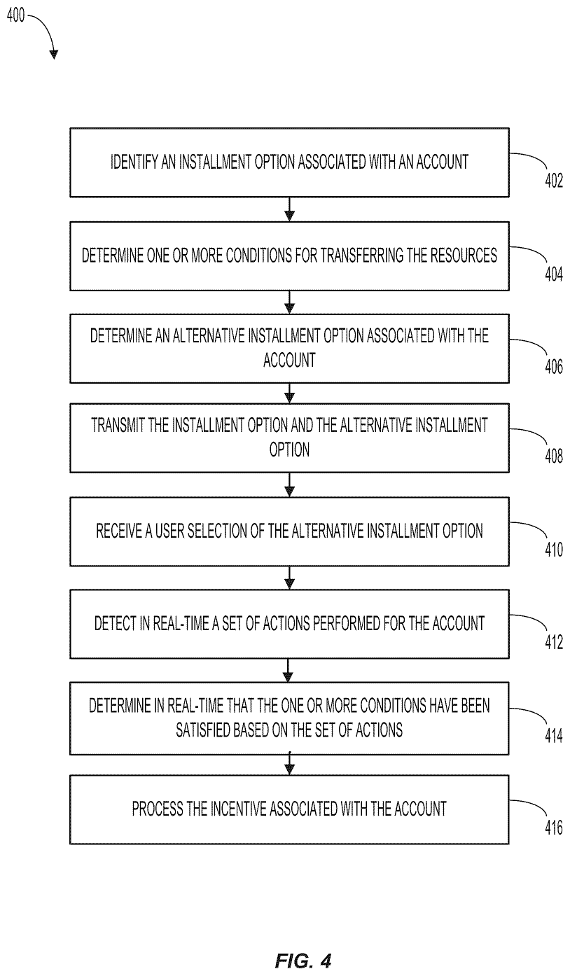

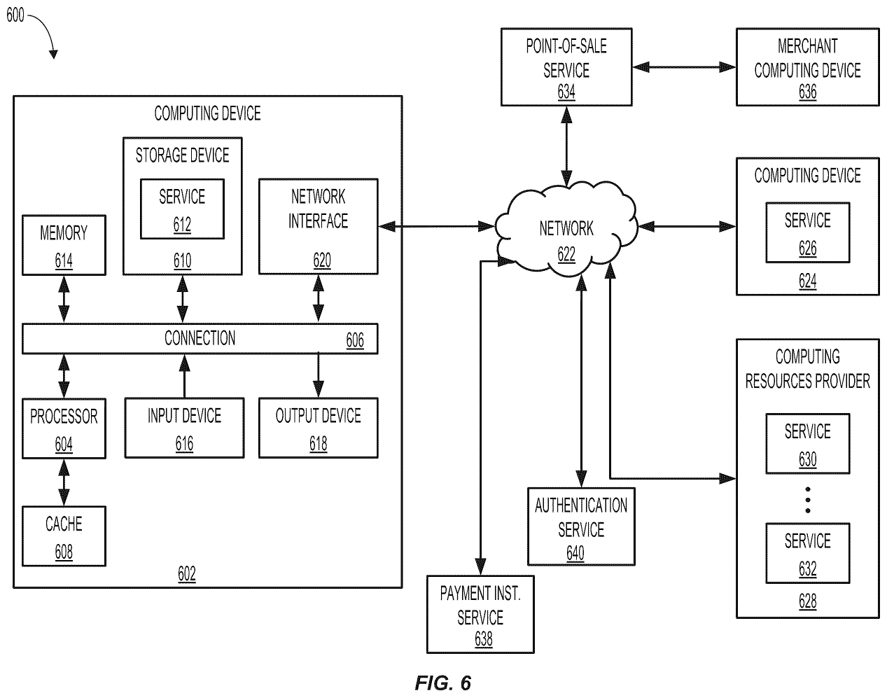

FIG. 4 shows an illustrative example of a process 400 for determining conditions and incentives associated with installment options, in accordance with some embodiments. For illustrative purposes, the process 400 is described with reference to the components illustrated in FIGS. 1-3, though other implementations are possible. For example, the program code for the incentive-management application 204 of FIG. 2, is executed by one or more processing devices to cause a server system (e.g., the computing device 602 of FIG. 6) to perform one or more operations described herein.

At step 402, An incentive-management application (e.g., the incentive-management application 204 of FIG. 2) identifies an installment option associated with an account. In some instances, the installment option identifies a first recurring transfer of resources across a time period (e.g., 48 months). In some instances, the resources were provided by a resource provider to complete a particular transaction for a user. By providing the resources, the resource provider can activate an account associated with the borrowed resources. To return the resources of the account, the user can be enrolled in an installment option that indicates a recurring transfer of a portion of the resources over a time period (e.g., 48 months). In some instances, the installment option is associated an interest to be added to the resources. The interest can be determined based on a percentage of the borrowed resources (e.g., an interest rate).

At step 404, the incentive-management application determines one or more conditions for transferring the resources. The conditions can specify certain actions to be performed for the account. When the actions are completed, the resource provider can provide corresponding incentives for the account. The conditions can include payment of an entirety of resources associated with the account before a particular date (e.g., within 24 months), in which the particular date is earlier than a maturation date associated with the time period (e.g., 48 months). In some instances, the conditions include activating an automatic withdrawal of the resources (e.g., autopay) that are associated with the second recurring transfer.

Additionally or alternatively, various parameters associated with the conditions can be configured by applying a machine-learning model to profile data of a user associated with the account. For example, the conditions can include one or more condition parameters, in which the condition parameters can be determined by applying the machine-learning model to profile data of the user. For example, the condition parameters associated with a promotional period can be determined as 24 months instead of 12 months.

At step 406, the incentive-management application determines an alternative installment option associated with the account. The alternative installment option identifies a second recurring transfer of resources across the time period. The alternative installment option can be associated with an incentive associated with the account, in which the incentive can be applied when the one or more conditions are satisfied. For example, if the installment option indicates an interest rate associated with resources of the account, the incentive of the alternative installment option can include a reduction of the interest rate associated with the installment option. In another example, if the installment option indicates an amount of interest to be applied to the resources of the account, the incentive of the alternative installment option can include waiving an entirety the indicated amount of interest. Additionally or alternatively, multiple incentives can be applied to the alternative installment options based on satisfaction of a single condition or multiple conditions.

Additionally or alternatively, various parameters associated with the incentive can be configured by applying a machine-learning model to profile data of the user. For example, the incentive can be associated with a particular type (e.g., waived interest, reduced interest rate, gifting promotional items), in which the type of incentives can be determined by applying a machine-learning model to the browsing history, posted messages, and previous purchases that are associated with the user. In another example, the incentive can include one or more incentive parameters, in which the incentive parameters are determined by applying the machine-learning model to the profile data of the user. For example, the incentive parameters can include an amount of interest being waived upon satisfaction of the condition. For example, the incentive parameters can identify a percentage of interest (e.g., 75%) to be waived if the conditions are satisfied, or a number of promotional items to be provided to the user if the conditions are satisfied.

At step 408, the incentive-management application transmits the installment option and the alternative installment option. When the installment option and the alternative installment option are received, a web service can cause the installment option and the alternative installment option to be displayed on one or more web pages. A user device can access the one or more web pages displayed on a browser to view and evaluate different installment options for returning the resources. A graphical user-interface element can be associated with a corresponding installment option, to allow the user to select one of the installment options for enrollment. For example, the incentive-management application can receive the user selection of the alternative installment option that involves recurring transfer of resources for 24 months with waived interest fees. The resource-management can then enroll the user to the alternative installment option.

At step 410, the incentive-management application receives a user selection of the alternative installment option. In response to the user selection, the incentive-management application can enroll the user to the alternative installment option. Once enrolled, the incentive-management application can monitor actions performed by the user to determine whether the conditions specified in the alternative installment option have been satisfied. For the example, the incentive-management application can receive the user selection of the alternative installment option that involves recurring transfer of resources for 24 months with waived interest fees. The resource-management can then enroll the user to the alternative installment option and monitor whether the user transferred the entirety of the borrowed resources within 24 months.

At step 412, the incentive-management application detects in real-time a set of actions performed for the account. In some instances, the set of actions are detected in real-time as a plurality of actions continue to be performed for the account. The set of actions can be associated with the one or more conditions. For example, the incentive-management application can detect that the recurring transfer of resources has been performed. In another example, the incentive-management application can detect that the automatic withdrawal has been activated for the account.

At step 414, the incentive-management application determines in real-time that the one or more conditions have been satisfied based on the set of actions. In some instances, the one or more conditions are determined to have been satisfied in real-time as the plurality of actions continue to be performed for the account. For example, the incentive-management application can continue to reduce the account balance with resources transferred each month. Once the account balance reduces to zero, the incentive-management application can identify a date at which the account balance became zero and compare the identified date with a date associated with the conditions (e.g., 24-month promotional date). If the identified date has occurred earlier than the 24-month promotional date, the incentive-management application can determine that the conditions have been satisfied.

At step 416, the incentive-management application processes the incentive associated with the account. For example, the incentive-management application can reduce the interest rate after determining that the automatic withdrawal has been activated by the user. In another example, the incentive-management application can waive the interest fees from the account balance once the entirety of the resources are transferred within the promotional period. Process 400 terminates thereafter.

### III. Machine-Learning Techniques for Determining Conditions and Incentives Associated With Installment Options

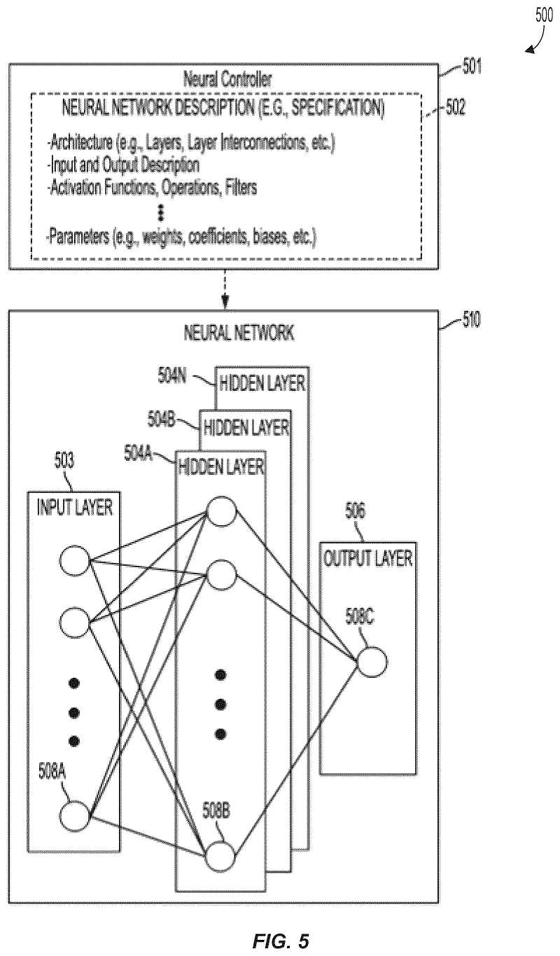

As described herein, a machine-learning model such as a clustering algorithm or a neural network can be trained to determine parameters of conditions and incentives associated with installment options. FIG. 5 illustrates an example architecture 500 of a neural network 510 for determining conditions and incentives associated with installment options, according to some embodiments. The neural network 510 defined by an example neural network description 502 for machine learning in a neural controller 501 (controller 501, which can be the same as a processing unit inside a mobile device). Neural network description 502 can include a full specification of the neural network 510, including the neural architecture 500. For example, the neural network description 502 can include a description or specification of architecture of the neural network 510 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc. and so forth.

In one example, input description can include profile data and output description can include parameters of conditions and incentives associated with installment options. For example, the output of the machine-learning model can include parameters of conditions (e.g., 24 months for promotional time period for waived interest) associated with installment options. In another example, the output of the machine-learning model can include parameters of incentives (e.g., reduced interest rate when autopay withdrawal is activated) associated with installment options. In yet another example, the output of the machine-learning model can include the output of the machine-learning model can include types of incentives (e.g., waiver of interest fees, discounts with goods and services provided by another service provider) associated with installment options.

As described herein, the profile data can include various types of data associated with the user. Similar to account data, the profile data can include PII of the user, including name, address, age, social security number, credit score, date and place of birth, mother's maiden name, or biometric records associated with the user. In some instances, the profile data does not include sensitive PII (e.g., social security numbers), to protect the user's privacy. In addition to the PII, the profile data can include data that indicates interactions or activities performed by the user, including interactions with a resource provider. For example, the profile data can include browsing history, posted messages, previous purchases that are associated with the user, any previous transfer of resources associated with the resource provider, any user accounts that are currently open, any user accounts that are currently closed, and other clickstream data. In some instances, the machine-learning model is applied to the profile data to determine the conditions and their respective parameters in real-time, such that the output generated based on the profile data at a given time point would be different relative to other outputs generated at a different time point (e.g., after 1 minute, after 5 minutes, after 10 minutes, after 15 minutes).

The neural network 510 can reflect the architecture 500 defined in neural network description 502. In this non-limiting example, the neural network 510 includes an input layer 503, which includes input data, which can be any type of data such as media content (images, videos, etc.), numbers, text, etc., associated with the profile data described above with reference to FIGS. 1-4. In one illustrative example, the input layer 503 can process data representing a portion of the input media data, such as a patch of data or pixels (e.g., a 128×128 patch of data) in an image corresponding to the input media data.

The neural network 510 can include hidden layers 504A through 504N (collectively “504” hereinafter). The hidden layers 504 can include n number of hidden layers, where n is an integer greater than or equal to one. The number of hidden layers can include as many layers as needed for a desired processing outcome and/or rendering intent. The neural network 510 further includes an output layer 506 that provides an output resulting from the processing performed by the hidden layers 504. In one illustrative example, an output layer 506 can provide the condition or incentive parameters to the neural network 510, in which the condition or incentive parameters can be associated with the corresponding installment options.

The neural network 510, in this example, is a multi-layer neural network of interconnected nodes. Each node can represent a piece of information. Information associated with the nodes is shared among the different layers and each layer retains information as information is processed. In some cases, the neural network 510 can include a feed-forward neural network, in which case there are no feedback connections where outputs of the neural network are fed back into itself. In other cases, the neural network 510 can include a recurrent neural network, which can have loops that allow information to be carried across nodes while reading in input.

Information can be exchanged between nodes through node-to-node interconnections between the various layers. Nodes of input layer 503 can activate a set of nodes in the first hidden layer 504A. For example, as shown, each input node of input layer 503 is connected to each node of first hidden layer 504A. Nodes of hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of output layer 506, at which point an output is provided. In some cases, while nodes (e.g., nodes 508A, 508B, 508C) in the neural network 510 are shown as having multiple output lines, a node has a single output and all lines shown as being output from a node represent the same output value. In examples described with reference to determining the incentive or condition parameters, the neural network 510, once trained, can have a single output that indicates such parameters at the output layer 506.

In some cases, each node or interconnection between nodes can have a weight that is a set of parameters derived from training the neural network 510. For example, an interconnection between nodes can represent a piece of information learned about the interconnected nodes. The interconnection can have a numeric weight that can be tuned (e.g., based on a training dataset), allowing the neural network 510 to be adaptive to inputs and able to learn as more data is processed.

In some instances, the neural network 510 is pre-trained to process the features from the data in the input layer 503 using different hidden layers 504 in order to provide the output through the output layer 506.

Various training and test data sets may be utilized to train the neural network 510 such that once trained, the neural network 510 can process various aspects of the profile data to determine the parameters of conditions and incentives. A large pool of profile data may be split into two classes of data called training data set and test data set. For example, 70% of the profile data from the pool may be used as part of the training data set while the remaining 30% of the profile data from the pool may be used as part of the test data set. The percentages according to which the pool of profile data are split into training data set and test data set is not limited to 70/30 and may be set according to a configurable accuracy requirement and/or error tolerance (e.g., the split can be 50/50, 60/40, 70/30, 80/20, 90/10, etc. between the two data sets).

The profile data can then be used to train the neural network 510 accompanied with manual feedback. With each condition or incentive parameter generated by the neural network 510, manual feedback can be provided to correct the output of the neural network 510, confirm the output of the neural network 510, etc. As noted, weights of different nodes of the neural network 510 may be adjusted/tuned during the training process to improve resulting output.

Once trained, the neural network 510 can be tested using profile data in test data set. Once the result of testing the neural network 510 is satisfactory (e.g., when outputs of the testing stage is greater than or equal to a threshold or incorrect detections are less than a threshold), the trained neural network 510 (which may also be referred to as a trained machine learning model or machine trained neural network) may be deployed for generating the conditions or incentives associated with the installment options.

In some cases, the neural network 510 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned.

For example, the forward pass can include passing a training image that represent a portion of the profile data through the neural network 510. The weights can be initially randomized before the neural network 510 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

The neural network 510 can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 510 can represent any other neural or deep learning network, such as an autoencoder, a deep belief nets (DBNs), a recurrent neural networks (RNNs), etc.

Neural Architecture Search (NAS) involves a process in which neural controller 501 searches through various types of neural networks such as CNNs, DBNs, RNNs, etc., to determine which type of neural network, given the input/output description of neural network description 502, can perform closes to the desired output once trained. This search process is currently cumbersome and resource intensive, because every type of available neural network is treated as a “blackbox.” In other words, a neural controller such as neural controller 501 selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

### IV. Example Systems

FIG. 6 illustrates a computing system architecture 600, including various components in electrical communication with each other, in accordance with some embodiments. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In an embodiment, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed techniques for determining conditions and incentives associated with installment options can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, identifying one or more conditions associated with installment options described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described herein, the connector 606 (or bus) can also couple the processor 604 to the storage device 610, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In an embodiment, the information can be delivered using a transfer protocol such as HTML, XML, JavaScript®, CSS, JSON, and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g. network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

In an embodiment, the computing device 602 can be connected to one or more additional computing devices and/or services such as merchant computing device 636 and/or a point-of-sale service 634 via the network 622 and using a connection such as the network interface 620. In an embodiment, the point-of-sale service 634 is separate from the merchant computing device 636. In an embodiment, the point-of-sale service 634 is executing on the merchant computing device 636. In an embodiment, the point-of-sale service 634 is executing as one or more services (e.g., the service 630 and/or the service 632) operating within the environment of the computing resources provider. As used herein, a point-of-sale service 634 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 636 to interact with the point-of-sale service 634. In an embodiment, the merchant computing device 636 is a dedicated point-of-service (POS) terminal. In an embodiment, the merchant computing device 636 is a cash register system. In an embodiment, the merchant computing device 636 is an application or web service operating on a computing device such as the computing device 602 described herein. In such an embodiment, the application or web service may be provided by a financial services system (e.g., a bank, a transaction processing system, an inventory management system, or some other such financial services system). In an embodiment, the merchant computing device 636 includes an auxiliary device or system to execute tasks associated with the point-of-sale service 634 (e.g., a payment instrument processing device attached to a smart phone or tablet). In an embodiment, the merchant computing device 636 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 636 is a virtual device (e.g., a virtual kiosk) such as the virtual devices described herein. Although not illustrated here, in an embodiment, the merchant computing device 636 may be one of a plurality of devices that may be interconnected using a network such as the network 622.

In an embodiment, the computing device 602 can be connected to one or more additional computing devices and/or services such as a payment instrument service 638 via the network 622 and using a connection such as the network interface 620. In an embodiment, the payment instrument service 638 connects directly with the point of sale service 634. In an embodiment, elements of the payment instrument service 638 are executing on the merchant computing device 636. In an embodiment, the payment instrument service 638 is executing as one or more services (e.g., the service 630 and/or the service 632) operating within the environment of the computing resources provider. As used herein, a payment instrument service 638 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 638 are running as an application or web service operating on a computing device such as the computing device 602 described herein. In such an embodiment, the application or web service of the payment instrument service 638 may be provided by a financial services system (e.g., a bank, a transaction processing system, an inventory management system, or some other such financial services system). In an embodiment, elements of the payment instrument service 638 are running on an auxiliary device or system configured to execute tasks associated with the payment instrument service 638 (e.g., uses a payment instrument processing device attached to a smart phone or tablet). In an embodiment, elements of the payment instrument service 638 are running on virtual device such as those described herein. Although not illustrated here, in an embodiment, the payment instrument service 638 may be running on one or more of a plurality of devices that may be interconnected using a network such as the network 622.

In an embodiment, the computing device 602 can be connected to one or more additional computing devices and/or services such as an authentication service 640 via the network 622 and using a connection such as the network interface 620. In an embodiment, the authentication service 640 is an element of the payment instrument service 638. In an embodiment, the authentication service 640 is separate from the payment instrument service 638. In an embodiment, the authentication service 640 connects directly with the point of sale service 634. In an embodiment, elements of the authentication service 640 are executing on the merchant computing device 636. In an embodiment, the authentication service 640 is executing as one or more services (e.g., the service 630 and/or the service 632) operating within the environment of the computing resources provider. As used herein, an authentication service 640 is a service used by one or more merchants to authenticate transactions associated with payment instruments. An authentication service may be a third-party service that provides secure and verified authorization of the transactions.

In an embodiment, elements of the authentication service 640 are running as an application or web service operating on a computing device such as the computing device 602 described herein. In such an embodiment, the application or web service of the authentication service 640 may be provided by a financial services system (e.g., a bank, a transaction processing system, an inventory management system, or some other such financial services system). In an embodiment, elements of the authentication service 640 are running on an auxiliary device or system configured to execute tasks associated with the authentication service 640 (e.g., provides authentication using payment instrument processing device attached to a smart phone or tablet). In an embodiment, elements of the authentication service 640 are running on virtual device such as those described herein. Although not illustrated here, in an embodiment, the authentication service 640 may be running on one or more of a plurality of devices that may be interconnected using a network such as the network 622.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 602) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 1124 will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method comprising:
identifying an installment option associated with an account, wherein the installment option identifies a first recurring transfer of resources across a time period;
determining one or more conditions for transferring the resources;
determining an alternative installment option associated with the account, wherein the alternative installment option identifies a second recurring transfer of resources across the time period, wherein the alternative installment option is associated with an incentive associated with the account, and wherein the incentive is applied when the one or more conditions are satisfied;
transmitting the installment option and the alternative installment option, wherein when the installment option and the alternative installment option are received, a web service causes the installment option and the alternative installment option to be displayed on one or more web pages;
receiving a user selection of the alternative installment option;
detecting in real-time a set of actions performed for the account, wherein the set of actions are associated with the one or more conditions, and wherein the set of actions are detected in real-time as a plurality of actions continue to be performed for the account;
determining in real-time that the one or more conditions have been satisfied based on the set of actions, wherein the one or more conditions are determined to have been satisfied in real-time as the plurality of actions continue to be performed for the account; and
processing the incentive associated with the alternative installment option.

2. The computer-implemented method of claim 1, wherein the installment option indicates an interest rate associated with resources of the account, and wherein the incentive of the alternative installment option includes a reduction of the interest rate associated with the installment option.

3. The computer-implemented method of claim 1, wherein the installment option indicates an amount of interest to be applied to the resources of the account, and wherein the incentive of the alternative installment option includes waiving an entirety the indicated amount of interest.

4. The computer-implemented method of claim 1, wherein the one or more conditions include payment of an entirety of resources associated with the account before a particular date, and wherein the particular date is earlier than a maturation date associated with the time period.

5. The computer-implemented method of claim 1, wherein the one or more conditions include activating an automatic withdrawal of the resources that are associated with the second recurring transfer.

6. The computer-implemented method of claim 1, wherein the incentive is associated with a particular type, and wherein the particular type of the incentive is determined by applying a machine-learning model to profile data of a user associated with the account.

7. The computer-implemented method of claim 1, wherein the one or more conditions include one or more condition parameters, and wherein the one or more condition parameters are determined by applying a machine-learning model to profile data of a user associated with the account.

8. The computer-implemented method of claim 1, wherein the incentive includes one or more incentive parameters, and wherein the one or more incentive parameters are determined by applying a machine-learning model to profile data of a user associated with the account.

9. A system, comprising:
one or more processors; and
memory storing thereon instructions that, as a result of being executed by the one or more processors, cause the system to perform operations comprising:
identifying an installment option associated with an account, wherein the installment option identifies a first recurring transfer of resources across a time period;
determining one or more conditions for transferring the resources;
determining an alternative installment option associated with the account, wherein the alternative installment option identifies a second recurring transfer of resources across the time period, wherein the alternative installment option is associated with an incentive associated with the account, and wherein the incentive is applied when the one or more conditions are satisfied;
transmitting the installment option and the alternative installment option, wherein when the installment option and the alternative installment option are received, a web service causes the installment option and the alternative installment option to be displayed on one or more web pages;
receiving a user selection of the alternative installment option;
detecting in real-time a set of actions performed for the account, wherein the set of actions are associated with the one or more conditions, and wherein the set of actions are detected in real-time as a plurality of actions continue to be performed for the account;
determining in real-time that the one or more conditions have been satisfied based on the set of actions, wherein the one or more conditions are determined to have been satisfied in real-time as the plurality of actions continue to be performed for the account; and
processing the incentive associated with the alternative installment option.

10. The system of claim 9, wherein the installment option indicates an interest rate associated with resources of the account, and wherein the incentive of the alternative installment option includes a reduction of the interest rate associated with the installment option.

11. The system of claim 9, wherein the installment option indicates an amount of interest to be applied to the resources of the account, and wherein the incentive of the alternative installment option includes waiving an entirety the indicated amount of interest.

12. The system of claim 9, wherein the one or more conditions include payment of an entirety of resources associated with the account before a particular date, and wherein the particular date is earlier than a maturation date associated with the time period.

13. The system of claim 9, wherein the one or more conditions include activating an automatic withdrawal of the resources that are associated with the second recurring transfer.

14. The system of claim 9, wherein the incentive is associated with a particular type, and wherein the particular type of the incentive is determined by applying a machine-learning model to profile data of a user associated with the account.

15. The system of claim 9, wherein the one or more conditions include one or more condition parameters, and wherein the one or more condition parameters are determined by applying a machine-learning model to profile data of a user associated with the account.

16. The system of claim 9, wherein the incentive includes one or more incentive parameters, and wherein the one or more incentive parameters are determined by applying a machine-learning model to profile data of a user associated with the account.

17. A non-transitory, computer-readable storage medium storing thereon executable instructions that, as a result of being executed by one or more processors of a computer system, cause the computer system to perform operations comprising:
identifying an installment option associated with an account, wherein the installment option identifies a first recurring transfer of resources across a time period;
determining one or more conditions for transferring the resources;
determining an alternative installment option associated with the account, wherein the alternative installment option identifies a second recurring transfer of resources across the time period, wherein the alternative installment option is associated with an incentive associated with the account, and wherein the incentive is applied when the one or more conditions are satisfied;
transmitting the installment option and the alternative installment option, wherein when the installment option and the alternative installment option are received, a web service causes the installment option and the alternative installment option to be displayed on one or more web pages;
receiving a user selection of the alternative installment option;
detecting in real-time a set of actions performed for the account, wherein the set of actions are associated with the one or more conditions, and wherein the set of actions are detected in real-time as a plurality of actions continue to be performed for the account;
determining in real-time that the one or more conditions have been satisfied based on the set of actions, wherein the one or more conditions are determined to have been satisfied in real-time as the plurality of actions continue to be performed for the account; and
processing the incentive associated with the alternative installment option.

18. The non-transitory, computer-readable storage medium of claim 17, wherein the installment option indicates an interest rate associated with resources of the account, and wherein the incentive of the alternative installment option includes a reduction of the interest rate associated with the installment option.

19. The non-transitory, computer-readable storage medium of claim 17, wherein the installment option indicates an amount of interest to be applied to the resources of the account, and wherein the incentive of the alternative installment option includes waiving an entirety the indicated amount of interest.

20. The non-transitory, computer-readable storage medium of claim 17, wherein the one or more conditions include payment of an entirety of resources associated with the account before a particular date, and wherein the particular date is earlier than a maturation date associated with the time period.

21. The non-transitory, computer-readable storage medium of claim 17, wherein the one or more conditions include activating an automatic withdrawal of the resources that are associated with the second recurring transfer.

22. The non-transitory, computer-readable storage medium of claim 17, wherein the incentive is associated with a particular type, and wherein the particular type of the incentive is determined by applying a machine-learning model to profile data of a user associated with the account.

23. The non-transitory, computer-readable storage medium of claim 17, wherein the one or more conditions include one or more condition parameters, and wherein the one or more condition parameters are determined by applying a machine-learning model to profile data of a user associated with the account.

24. The non-transitory, computer-readable storage medium of claim 17, wherein the incentive includes one or more incentive parameters, and wherein the one or more incentive parameters are determined by applying a machine-learning model to profile data of a user associated with the account.
